(19) United States
(12) Patent Application Publication
(10) Pub. No.: US 2004/0029563 A1
(43) Pub. Date: Feb. 12, 2004

(54) Method and system for controlling access

(76) Inventor: Thornsten Berg, (US)

Correspondence Address: BELL, BOYD & LLOYD, LLC, P. O. BOX 1135, CHICAGO, IL, 60690-1135, US

(21) Appl. No.: 10/380,337

(22) PCT Filed: Aug. 28, 2001
(86) PCT No.: PCT/DE01/03278

(30) Foreign Application Priority Data
Sep. 11, 2000 (DE) 100 44 834.8

(51) Int. Cl. H04M 1/66; H04M 1/68; H04M 3/16

(52) U.S. Cl. 455/410; 455/411

(57) ABSTRACT

The invention relates to a method and a system for controlling access, comprising a mobile radio transmission/radio receiving device with a first limited short radio coverage range. The system also has at least one electronic device with a short-range radio transmission/radio receiving module which has a second limited short radio coverage range. The mobile radio transmission/radio receiving device and the short-range radio transmission/radio receiving module are configured in such a way that when the first short radio coverage range at least partially overlap, messages are transmitted for identification. The short-range radio transmission/radio receiving module and the electronic device are also interconnected and configured in such a way that the identification messages that are transmitted are used to check authorization to use the functions of the electronic device. The short-range radio transmission/radio receiving module and the electronic device also have release means which are configured in such a way that the functions of the electronic device are released for use in the case of authorization and the use of these functions is blocked when the overlap no longer exists.

### BACKGROUND OF THE INVENTION

It is known practice to restrict access to data processing terminals (PC, Notebook, PDA, workstation etc.) or communication terminals, such as GSM mobile telephones, to a single person or to a group of users by providing the single person or the member of the group of users with authorization to access the terminal only after a code word has been input.

Since it becomes more and more likely that input of the code word will be observed as the frequency of input increases or as the duration of the code word's validity increases, it is normal practice to change the code word at regular intervals of time; particularly, in data processing installations storing confidential private or business data.

Due to the fact that code words are frequently changed, code words are frequently forgotten or are repeatedly input incorrectly, whereby the identifier is disabled and this disabled state then needs to be cancelled, usually by a higher authority, such as a network administrator, by resetting the code word to a default value or by enabling the identifier. Until this is done, it is not possible to use the unit, however.

The situation is similar with GSM mobile telephones where repeated input of an incorrect “PIN” code word results in the code word being disabled, this disabled state being cancelable only by inputting a higher “Super PIN” code word. This super PIN is more extensive than the PIN, however, and for this reason, and also because its rare use, is usually not retained in the memory. As such, a mobile telephone user first needs to look for the records containing the super PIN which, as prescribed, are kept separately from the mobile telephone, and then needs to input the super PIN in order to be able to telephone again.

Besides communication and data processing terminals, there are also a large number of other applications forming part of everyday life (automatic cash dispenser, EC cash facility, theft prevention, alarm system, etc.) which involve access authorization or the identity being verified via the input of a code word. Since different code words are generally used for this application in each case, this likewise increases the likelihood of the code words being forgotten or even mixed up.

An object to which the present invention is directed is to specify a system and a method for access control which improves the known methods and systems for access control.

### SUMMARY OF THE INVENTION

The inventive system for access control has a mobile radio transmission/radio reception unit having a first limited short-haul radio coverage area. In addition, it has at least one electronic unit having a short-haul radio transmission/radio reception module which has a second limited short-haul radio coverage area. The mobile radio transmission/radio reception unit and the short-haul radio transmission/radio reception module are in a form such that messages for identification are transmitted when there is at least some overlap between the first short-haul coverage area and the second short-haul radio coverage area. In addition, the short-haul radio transmission/radio reception module and the electronic unit are connected to one another, and are in a form, such that the transmitted identification messages are used to check authorization for use of the functions of the electronic unit. Furthermore, the short-haul radio transmission/radio reception module and the electronic unit have enabling parts which are in a form such that use of the functions of the electronic unit is enabled if there is authorization, and use of the functions is disabled if there is no longer any overlap.

In the case of the inventive method for access control, messages for identification are transmitted if there is at least some overlap between a first limited short-haul radio coverage area for a mobile radio transmission/radio reception unit and a second limited radio coverage area for a short-haul radio transmission/radio reception module associated with an electronic unit. In another step, the transmitted identification messages are then evaluated. If evaluation reveals that there is authorization to use the electronic unit, use of the functions of the electronic unit is enabled. Use of the function of the electronic unit is disabled in a further step as soon as there is no longer any overlap. The present invention permits an electronic unit to have access control which does not involve the user of the unit having to remember a code word which he/she needs to input to enable the functions. Instead, access is enabled automatically at the instant at which the user enters the electronic unit's or his/her radio module's radio coverage area with a radio transmission/radio reception unit in a form based on the present invention. So to speak, access also can be disabled by taking the inventive radio transmission/radio reception unit out of the radio coverage area for the electronic unit's radio module again, so that manual disablement is no longer necessary and there is also no time delay as there is in known systems. Since the inventive radio transmission/radio reception unit is in a mobile form, it is also possible to use this mobile radio transmission/radio reception unit for access or for access control on other electronic units whose design is based on the present invention. If, in one advantageous embodiment of the present invention, provision is made for the mobile radio transmission/radio reception unit to repeatedly send an identification message, with this identification message containing an identifier which is associated with the mobile radio transmission/radio reception unit and is unique in the system, then it is merely necessary for the short-haul radio transmission/radio reception module to receive the transmitted identification message when there is an overlap between the first short-haul radio coverage area and the second short-haul radio coverage area and to check the identifier it contains to determine whether the identifier provides authorization to enable the use of the functions of the electronic unit, with use of the electronic unit being enabled if there is authorization. The electronic unit, therefore, merely needs to store the identifiers which are authorized to use this unit and which are then used to check authorization. The inventive short-haul radio transmission/radio reception module, therefore, needs to be active for access control only when it is receiving identification messages. This is particularly advantageous, by way of example, if the electronic unit needs to be used in a particularly energy-saving manner; for example, because it is dependent on supply by batteries or by storage batteries.

An embodiment in which the short-haul radio transmission/radio reception module is in a form such that it repeatedly requests identification messages is advantageous in the situations in which the mobile radio transmission/radio reception unit is dependent on supply by batteries or storage batteries and, therefore, needs to be operated in a particularly energy-saving manner.

If both the mobile radio transmission/radio reception unit and the short-haul radio transmission/radio reception module operate on the basis of the Bluetooth standard, then this has the advantage that, in line with the Bluetooth specification, (optionally) the transmission power can be chosen to have a setting below 0 dbm, whereby the range of the radio transmission/radio reception units or of the modules is restricted to between 0 and 2 meters in order to ensure that only those inventive electronic units are enabled in whose immediate surroundings the user is situated. In addition, it has the advantage that the Bluetooth standard, which is a short-haul radio standard, operates at carrier frequencies from the Industrial Scientific Medical 2.4 GHz (ISM band), which is unlicensed throughout the world and, at a transmission power of precisely 0 dm (in line with the Bluetooth specification), permits bi-directional wireless connection within a radius of between 1 and 10 meters and, at a transmission power of 20 dbm (in line with the Bluetooth specification), permits bi-directional wireless connection within a radius of between 10 and 100 meters from terminals, with radio interference being prevented by changing the carrier frequencies in a pseudo-random order up to 1600/s.

Using the unique Bluetooth address, provided in line with the Bluetooth standard, as an identifier has the advantage that it ensures clear association with the inventive mobile radio transmission/radio reception unit throughout the world, since every manufacturer assigns a unique 48-bit address, allowing over 281 billion combinations, for a unit operating in line with the Bluetooth standard.

If the messages for identification are transmitted as part of a login procedure performed in line with the Bluetooth standard, standard Bluetooth radio modules can be used to implement the inventive system or method, this requiring only a small amount of development for the electronic unit holding the radio module.

If the mobile radio transmission/radio reception unit has the form and dimensions of the smart card, it is particularly easy to transport and can be used as an ID card, for example.

If the mobile radio transmission/radio reception unit is integrated into a wristwatch, it is likewise easy to transport and is always at hand.

Additional features and advantages of the present invention are described in, and will be apparent from, the following Detailed Description of the Invention and the Figures.

### BRIEF DESCRIPTION OF THE FIGURES

FIG. 1 shows the inventive system for access control with radio modules designed in line with the Bluetooth standard.

### DETAILED DESCRIPTION OF THE INVENTION

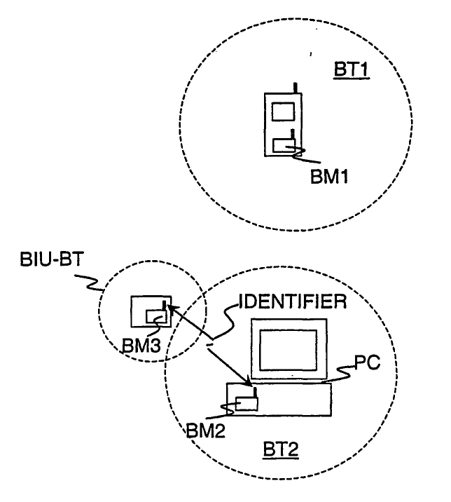

FIG. 1 shows an inventive system. The illustration shows a mobile part MP, a personal computer PC and an identification unit BIU, this identification unit BIU being in the form of a smart card and being able to be carried by a person.

Each of these three units shown has a radio module operating on the basis of the Bluetooth standard. Specifically, the mobile part MP has a first short-haul radio transmission/radio reception module BM1, the personal computer PC has a second short-haul radio transmission/radio reception module BM2, and the identification unit BIU has a third short-haul radio transmission/radio reception module BM3. The first short-haul radio transmission/radio reception module BM1 has a first short-haul radio coverage area BT1, and the second short-haul radio transmission/radio reception module BM2 has a second short-haul radio coverage area BT2, in each case with a radius which can be between 1 and 10 meters, at 0 dbm transmission power, or even up to 10 or 100 meters, at 20 dbm transmission power.

According to the present invention, only the third short-haul radio transmission/radio reception module BM3, which has a third short-haul radio coverage area BIU-BT, is operated at a transmission power of below 0 dbm in order to restrict the third short-haul radio coverage area to 0 m-2 m, for example.

The first short-haul radio transmission/radio reception module BM1 and the second short-haul radio transmission/radio reception module BM2 shown in FIG. 1 are preferably operated, by way of example, at 20 dbm, so that they can perform other functionalities (data alignment or other Bluetooth applications) within a radius of between 10 and 100 meters.

The third short-haul radio transmission/radio reception module BM3 has a transmission power of below 0 dbm, which means that there is a third short-haul radio coverage area BIU-BT of between 0 and 2 meters.

In the system shown in FIG. 1, the second short-haul radio coverage area BT2 overlaps the third short-haul radio coverage area BIU-BT, whereby a login procedure performed in line with the Bluetooth standard is performed using a wireless connection which is possible on account of the overlap.

During the login procedure, an identifier IDENTIFIER is transmitted to the personal computer PC. The identifier is the Bluetooth address of the third short-haul radio transmission/radio reception module BM3, the Bluetooth address being requested in line with the Bluetooth standard, being allocated to every Bluetooth unit by the actual manufacturer and having a length of 48 bits, which allows the formation of 281 billion addresses, so that unique addressing of a Bluetooth unit throughout the world is ensured.

Using the second short-haul radio transmission/radio reception module BM2, an enabling device in the personal computer PC receives the identifier IDENTIFIER and compares this identifier IDENTIFIER with the access-authorized identifiers which are known to it, having been indicated by an administrator, for example, and which are stored in the personal computer PC or in the enabling device.

Besides the identifier, alternatively, such as upon request by the enabling device, additionally or instead of the identifier, identification messages, such as personal data relating to the holder of the identification device for the purpose of implementing an ID/passport function, can be transmitted from the identification device to the enabling device using the wireless connection.

If the comparison reveals that the transmitted identifier IDENTIFIER is an access-authorized identifier, the personal computer PC is enabled. As such, the user holding the identification unit BIU logs into the personal computer PC, with the enabling device being able to be in a form such that only some of the functions of the personal computer are enabled, whereby it is possible to differentiate access authorization.

The functions remain enabled for as long as the third short-haul radio coverage area BIU-BT for the third short-haul radio transmission/radio reception module BM3, contained in the identification unit BIU, overlaps the second short-haul radio coverage area for the second short-haul radio transmission/radio reception module BM3, fitted in the personal computer PC.

If the holder of the identification unit BIU moves away from the personal computer, so that there is no overlap between the second short-haul radio coverage area BT2 and the third short-haul radio coverage area BIU-BT, then this is detected, in line with the Bluetooth standard, by the second short-haul radio transmission/radio reception module BM2 fitted in the personal computer (e.g., disconnection/termination of the wireless connection) and is signaled to the enabling device, whereupon the personal computer PC is disabled or the user is logged out.

With the specific distribution of the transmission powers described above for the individual short-haul radio transmission/radio reception modules BM1, BM2 and BM3, the following scenario arises when the identification unit BIU is moved away from the personal computer PC again.

The identification unit BIU is at a distance of 15 m, for example, from the PC. The third short-haul radio transmission/radio reception module BM3 in the identification unit BIU still receives Bluetooth data from the personal computer PC and also sends out responses which, due to the minimized transmission range of the third short-haul radio transmission/radio reception module BM3, cannot be received by the second short-haul radio transmission/radio reception module BM2, however. As such, there is no longer any overlap, so that the personal computer PC is disabled.

If the identification unit BIU is moved in the direction of the personal computer PC again and is at a distance of less than 2 meters, the holder of the identification unit BIU is logged into the personal computer again.

This ensures that the personal computer PC is only enabled when the user with access authorization is in the immediate vicinity of the personal computer PC. Time-controlled automatic disablement is dispensed with. Input of a code word to enable a disabled state is likewise dispensed with, since, when the overlap reappears, the Bluetooth login procedure is performed and, hence, the enabling device logs in.

It is likewise possible for the third short-haul radio coverage area BIU-BT to overlap both the second short-haul radio coverage area BT2 and the first short-haul radio coverage area BT1, as well as other short-haul radio coverage areas. In this case, the holder of the identification unit is logged in both on the personal computer and on the mobile part MP shown in FIG. 1. If the Bluetooth address transmitted as part of the Bluetooth login procedure is identified as an access-authorized identifier by an inventive enabling device contained in the mobile part MP, then the holder can use both the functions of the personal computer and the functions of the mobile part MP.

Although the present invention has been described with reference to specific embodiments, those of skill in the art will recognize that changes may be made thereto without departing from the spirit and scope of the present invention as set forth in the hereafter appended claims.

1. A system for access control having the following features:
a) a mobile radio transmission/radio reception unit (BIU, BM3) has a first limited short-haul radio coverage area (BIU-BT),
b) at least one electronic unit (MP, PC) contains a short-haul radio transmission/radio reception module (BM1, BM2) which has a second short-haul radio coverage area (BT1, BT2),
c) the mobile radio transmission/radio reception unit (BIU, BM3) and the short-haul radio transmission/radio reception module (BM1, BM2) are in a form such that messages for identification are transmitted if there is at least some overlap between the first short-haul radio coverage area (BIU) and the second short-haul radio coverage area (BT1, BT2),
d) the short-haul radio transmission/radio reception module (BM1, BM2) and the electronic unit (MP, PC) are connected to one another such, and are in a form such, that the transmitted identification messages are used for checking authorization to use the functions of the electronic unit (MP, PC),
e) enabling means in a form such that use of the functions of the electronic unit (MP, PC) is enabled if there is authorization, and use of the functions is disabled if there is no longer any overlap.

2. The system as claimed in claim 1, characterized in that
a) the mobile radio transmission/radio reception unit (BIU, BM3) is in a form such that it repeatedly transmits an identification message, with the identification message containing an identifier (IDENTIFIER) which is associated with the mobile radio transmission/radio reception unit (BIU, BM3) and is unique in the system,
b) the short-haul radio transmission/radio reception module (BM1, BM2) is in a form such that the transmitted identification message is received when there is at least some overlap between the first short-haul radio coverage area (BIU-BT) and the second short-haul radio coverage area (BT1, BT2),
c) the short-haul radio transmission/radio reception module (BM1, BM2) and the electronic unit (MP, PC) are connected to one another such, and are in a form such, that the identifier (IDENTIFIER) contained in the identification message is checked to determine whether the identifier provides authorization to enable use of the functions of the electronic unit (MP, PC),
d) use of the functions is enabled only if there is authorization.

3. The system as claimed in claim 1, characterized in that
a) the short-haul radio transmission/radio reception module (BM1, BM2) is in a form such that it repeatedly requests identification messages,
b) the mobile radio transmission/radio reception unit (BIU, BM3) is in a form such that it transmits an identification message upon request, the identification message containing an identifier (IDENTIFIER) which is associated with the mobile radio transmission/radio reception unit (BIU, BM3) and is unique in the system,
c) the short-haul radio transmission/radio reception module (BM1, BM2) and the electronic unit are connected to one another such, and are in a form such, that the identifier (IDENTIFIER) contained in the identification message is checked to determine whether the identifier provides authorization to enable use of the functions of the electronic unit (MP,PC),
d) use of the functions is enabled only if there is authorization.

4. The system as claimed in claim 1, characterized in that the mobile radio transmission/radio reception unit (BIU, BM3) and the short-haul radio transmission/radio reception module (BM1, BM2) are in a form such that they operate on the basis of the Bluetooth standard.

5. The system as claimed in claim 4, characterized in that the identifier is the unique Bluetooth address.

6. The system as claimed in claim 5, characterized in that the mobile short-haul radio transmission/radio reception unit (BIU, BM3) and the short-haul radio transmission/radio reception module (BM1, BM2) are in a form such that the [lacuna] transmitted messages for identification is carried out as part of a login procedure performed in line with the Bluetooth standard.

7. The system as claimed in one of claims 1 to 6, characterized in that the mobile radio transmission/radio reception unit (BIU, BM3) has the form and dimensions of a smart card.

8. The system as claimed in one of claims 1 to 6, characterized in that the mobile radio transmission/radio reception unit (BIU, BM3) is integrated in a wristwatch.

9. A method for access control having the following features:
a) messages for identification are transmitted if there is at least some overlap between a first limited short-haul radio coverage area (BIU-BT) for a mobile radio transmission/radio reception unit (BIU, BM3) and a second limited short-haul radio coverage area (BT1, BT2) for a short-haul radio transmission/radio reception module (BM1, BM2) associated with an electronic unit (MP, PC),
b) the transmitted identification messages are evaluated,
c) use of the functions of the electronic unit (MP, PC) [lacuna] the short-haul radio transmission/radio reception module (BM1, BM2) is enabled if evaluation reveals that there is authorization to use the electronic unit (MP, PC),
d) use of the function of the electronic unit (MP, PC) is disabled as soon as there is no longer any overlap.

10. The method as claimed in claim 9, characterized in that
a) the mobile radio transmission/radio reception unit (BIU, BM3) repeats an identification message, the identification message containing an identifier (IDENTIFIER) which is associated with the mobile radio transmission/radio reception unit (BIU, BM3) and is unique in the system,
b) the short-haul radio transmission/radio reception module (BM1, BM2) detects and receives transmitted identification message when there is at least some overlap between the first short-haul radio coverage area (BIU-BT) and the second short-haul radio coverage area (BT1, BT2),
c) the identifier (IDENTIFIER) contained in the identification message is checked to determine whether the identifier (IDENTIFIER) provides authorization to enable use of the functions of the electronic unit (MP, PC),
d) use is enabled only if there is authorization.

11. The method as claimed in claim 10, characterized in that
a) the short-haul radio transmission/radio reception module (BM1, BM2) repeatedly requests identification messages,
b) the mobile radio transmission/radio reception unit (BIU, BM3) transmits an identification message upon request, the identification message containing an identifier (IDENTIFIER) which is associated with the mobile radio transmission/radio reception unit (BIU, BM3) and is unique in the system,
c) the identifier (IDENTIFIER) contained in the identification message is checked to determine whether the identifier provides authorization to enable use of the functions of the electronic unit (MP, PC),
d) use is enabled only if there is authorization.

12. The method as claimed in claim 9, characterized in that the mobile radio transmission/radio reception unit (BIU, BM3) and the short-haul radio transmission/radio reception module (BM1, BM2) are in a form such that they operate on the basis of the Bluetooth standard.

13. The method as claimed in claim 12, characterized in that the identifier (IDENTIFIER) used is the unique Bluetooth address.

14. The system as claimed in claim 13, characterized in that the mobile radio transmission/radio reception unit (BIU, BM3) and the short-haul radio transmission/radio reception module (BM1, BM2) are in a form such that the [lacuna] transmitted messages for identification is carried out as part of a login procedure performed in line with the Bluetooth standard.

15. The method as claimed in one of the preceding claims, characterized in that the identifier (IDENTIFIER) is checked by comparing the identifier (IDENTIFIER) with reference identifiers stored in the radio transmission/radio reception module (BM1, BM2) or in the electronic unit (MP, PC).
